(19) United States
(12) Patent Application Publication
(10) Pub. No.: US 2010/0129612 A1
(43) Pub. Date: May 27, 2010

(54) ELECTRICALLY CONDUCTING LAYER STRUCTURE AND PROCESS FOR THE PRODUCTION THEREOF

(75) Inventors: Michael Rohm, Furth (DE); Juri Attner, Burgthann (DE)

Correspondence Address: HOFFMANN & BARON, LLP, 6900 JERICHO TURNPIKE, SYOSSET, NY, 11791, US

(73) Assignee: LEONHARD KURZ STIFTUNG & CO. KG, Furth (DE)

(21) Appl. No.: 12/467,590

(22) Filed: May 18, 2009

(30) Foreign Application Priority Data
May 20, 2008 (DE) 102008024451.1-34

(51) Int. Cl. B32B 3/30; B44C 1/22

(52) U.S. Cl. 428/172; 216/13

(57) ABSTRACT

The invention concerns a process for the production of at least one electrically conducting layer structure (5′″) of a pattern configuration on an electrically insulating substrate (1) and an electrically conducting layer structure (5′″) which is produced in accordance therewith and which in the plane of the layer is of dimensions of smaller than 20 mm in all directions.

### BACKGROUND OF THE INVENTION

The invention concerns a process for the production of at least one electrically conducting layer structure in a pattern configuration on an electrically insulating substrate, and an electrically conducting layer structure produced in accordance therewith.

Processes of that kind are known from EP 1 562 412 A2. In that case, in a continuous procedure, an electrically insulating substrate in the form of a film strip is transported in a roll-to-roll process. Electrically conducting pattern regions which are in the desired shape of the electrically conducting layer structures to be produced are formed on the film strip by means of applying an electrically conducting printing medium by a printing operation. The film strip prepared in that way is transported through galvanic baths and the electrically conducting pattern regions are galvanically enhanced with a metal layer. In the galvanic bath the film web is conveyed over a rotating drum which at its periphery and parallel to the axis of rotation of the drum has a number of mutually spaced cathode bars. In that procedure the electrically conducting pattern regions, while passing through the galvanic bath, must come into direct contact with a cathode bar and at the same time direct contact with the galvanic bath in order to be electrically contacted and to achieve metal deposit in the pattern regions.

The spacings present between the cathode bars mean that it is necessary for the electrically conducting pattern regions to be of a minimum dimension in the direction of transport of the film strip, such dimension ensuring that, while passing through the bath, the electrically conducting pattern region necessarily comes into electrically conducting contact with a cathode bar and into contact with the galvanic bath so that a deposition process takes place in the electrically conducting pattern region. In that respect the minimum dimension for an electrically conducting pattern region is at the present time >20 mm as considered in the film strip transport direction.

The ever progressing endeavours to miniaturise electrical components and circuitry encounter a limit with the processes available hitherto, as electrically conducting layer structures of a dimension of less than 20 mm—viewed in the film strip transport direction—cannot be reliably produced therewith on an electrically insulating substrate. With such small pattern regions to be coated, either a lack of electrical contact with a cathode bar or complete coverage of the pattern region to be coated, with the cathode bar, with displacement of the bath composition, prevents metal deposition in the pattern region.

### SUMMARY OF THE INVENTION

Therefore the object of the invention is on the one hand to provide a process with which even electrically conducting layers of a pattern configuration and of dimensions of markedly less than 20 mm can be produced on an electrically insulating substrate, and on the other hand to provide electrically conducting layer structures produced in accordance therewith, of smaller dimensions than hitherto possible.

That object is attained for the process for the production of at least one electrically conducting layer structure of a pattern configuration on an electrically insulating substrate, by the following steps:

applying an electrically conducting layer to at least one surface of the substrate;

producing an electrically insulating resist layer in a first region of the electrically conducting layer, wherein at least one second region of the electrically conducting layer is left free in the shape of the at least one patterned layer structure to be formed and in addition at least one strip-shaped third region of the electrically conducting layer is left free, wherein the first, second and third regions of the electrically conducting layer are electrically conductingly connected together and the at least one third region has ends which viewed in the longitudinal direction of the at least one third region project at least at one side beyond the at least one second region;

galvanically depositing a metal layer in the at least one second region and the at least one third region of the electrically conducting layer;

removing the resist layer; and producing the at least one patterned layer structure by the removal by etching of the electrically conducting layer in the first region and in addition the metal layer respectively on the side thereof that is remote from the substrate until the electrically conducting layer is removed in the first region.

In that respect the expression strip-shaped region is used to denote a region which is of an elongate configuration and is thus longer than it is wide.

The process according to the invention involves starting from an electrically conducting layer which is applied to the substrate over the full surface area or only in region-wise manner, in particular in pattern form. When the electrically conducting layer is provided over the entire surface area involved, in that way small second regions in which the electrically conducting layer is to be galvanically built up to afford an electrically conducting layer structure are still connected in good electrically conducting relationship with the portions of the electrically conducting layer, that are exposed in the strip-shaped third regions. When the electrically conducting layer is produced only in region-wise manner, in particular in pattern form in the shape of the electrically conducting layer structure to be formed, the second and third regions of the electrically conducting layer are produced in electrically conducting interconnected relationship, preferably by way of auxiliary conductor tracks which are also a component part of the electrically conducting layer.

By virtue of the production of the at least one second region in electrically conducting connected relationship with the at least one strip-shaped third region and by virtue of the configuration thereof, it is always possible to electrically contact the electrically conducting layer by means of a cathode bar, in the at least one third region, and to achieve galvanic deposition of metal in the at least one second region electrically conductingly connected thereto.

In that case the at least one second region and also the exposed at least one third region of the electrically conducting layer is galvanically coated while no galvanic deposition occurs in the first region, which is covered with the electrically insulating resist layer, of the electrically conducting layer. That saves on material and permits the individual layer structures to be easily cut out of an electrically conducting layer involving the full surface area, on the substrate, or permits separation of the individual layer structures formed in relation to the electrically conductive layer produced in region-wise manner on the substrate, from the other regions of the electrically conducting layer structure.

The object is attained for the electrically conducting layer structure formed by the process according to the invention by virtue of the layer structure in the plane of the layer in all directions being of dimensions of smaller than 20 mm, particularly preferably smaller than 10 mm, in particular preferably smaller than 1 mm.

It will be appreciated however that the process according to the invention can also be used for the formation of layer structures of larger dimensions, which for example are of a length of >70 mm.

Hitherto such small electrically conducting layer structures could only be built up on an electrically insulating substrate by considerably more expensive processes such as printing conductive pastes, with a sufficient thickness, or current-less plating.

The at least one strip-shaped third region can be produced on the substrate with a straight, inclined, stepped, wavy line-shaped or curved configuration. In that case the configuration of the at least one strip-shaped third region is adapted in particular to the arrangement of the layer structures to be formed, on the substrate.

It has proven worthwhile if at least two strip-shaped third regions are produced. That permits optimum utilisation of the available substrate surface area for forming the layer structures. There can also be three or more strip-shaped third regions.

In that respect the at least two strip-shaped third regions are preferably arranged in mutually parallel relationship, but another arrangement relative to each other is also possible. Thus third regions can cross over each other, extend at an angle relative to each other and/or extend at an angle relative to a longitudinal edge of the substrate, and the like.

Preferably the at least one strip-shaped third region is produced with a strip length of at least 20 mm. Irrespective of an arrangement of the at least one third region, that reliably permits electrical contacting of the electrically conducting layer by means of a cathode bar in at least one third region.

It has proven worthwhile if the at least one strip-shaped third region is produced adjoining an edge, in particular a longitudinal edge, of the substrate. Such an arrangement permits uniform electrical contacting of the electrically conducting layer in the region of the entire surface of the substrate.

It is however equally possible that the at least one strip-shaped third region is provided spaced from an edge, in particular a longitudinal edge, of the substrate. That can be advantageous in particular if it is not possible to achieve a uniform and uninterrupted configuration in respect of the electrically conducting layer in the edge region of the substrate, for example because of existing roughness or similar. An arrangement of a third region in the center of the substrate has proven advantageous.

Preferably the at least one strip-shaped third region is of such a configuration that it extends over a length of the substrate. When dealing with elongate substrates, a respective third region preferably extends along a respective one of the longitudinal edges of the substrate or a single third region extends in the center between the two longitudinal edges. By virtue of that arrangement, electrical contacting of the at least one third region and thus also the at least one second region of the electrically conducting layer can be achieved everywhere by means of the cathode bars.

To achieve metal plating which is as uniform as possible of the electrically conducting layer in the at least one second region, it has proven advantageous if a strip-shaped third region which is electrically contacted by means of a cathode bar is arranged per 5 cm through 20 cm, in particular 10 cm, of width of the substrate. Depending on the respective layout of the second regions, third regions are preferably arranged in gaps between second regions.

Equally however it is possible that the at least one strip-shaped third region is of such a configuration that it extends only over a portion of the substrate. When there are two or more third regions, there are different kinds of arrangement thereof relative to each other.

Thus a multiplicity of third regions can be arranged in succession in the longitudinal direction of the substrate. The successively arranged third regions are in that case interrupted for example by a first region with the resist layer. Such an arrangement is advantageous in particular when the at least one second region is present in locally restricted form or a plurality of second regions are present at the same height closely in mutually juxtaposed relationship, for example in a line, in which case however the spacing from a second region to a second region which is adjacent in the longitudinal direction of the substrate, or for example from a line to an adjacent line, is relatively great. Here, at the same height signifies transversely relative to the longitudinal direction of the substrate. Correspondingly, a line of second regions is an arrangement of the second regions transversely relative to the longitudinal direction of the substrate.

In addition, at least two strip-shaped third regions can be produced in such a way that they are of identical or different lengths. In that respect it has proven desirable if the ends of the at least two strip-shaped third regions are respectively arranged at the same height or in mutually displaced relationship, that is to say at different locations in the longitudinal direction of the substrate.

Irrespective of the length of a third region it has proven advantageous if the at least one strip-shaped third region is of such a configuration that it is of a width b of at least 1.0 mm. Preferably a plurality of strip-shaped third regions are of equal widths b, but different widths b can also be of advantage, for example in regard to electrical contacting. It is possible for at least two strip-shaped third regions to be formed, which are of a differing width b.

In regard to an electrically conducting layer which is only provided in region-wise fashion on the substrate, such a width b is also preferred in regard to the auxiliary conductor tracks which electrically conductingly connect the at least one second region to the at least one third region.

In a particularly preferred feature, the process according to the invention involves the use of an elongate flexible substrate so that a continuous process implementation then becomes possible. In that case the elongate flexible, that is to say bendable substrate is preferably transported from roll to roll during the process.

For that purpose the substrate is provided in a condition of being wound up on to a roll, it is drawn therefrom and it is passed directly to a unit for applying the electrically conducting layer. The substrate is then passed to at least one unit for producing the resist layer in pattern form in the first region on the electrically conducting layer, a galvanising unit for galvanically reinforcing the exposed second and third regions of the electrically conducting layer, a unit for removing the resist layer, a unit for etching the electrically conducting layer and the metal layer, and optionally further cleaning units, drying and/or temperature control units, units for individually separating a plurality of electrically conducting layer structures formed on the substrates, or units for further processing thereof.

The use of an electrically insulating substrate in the form of a film web, in particular a film web of a film thickness in the region of between 12 μm and 200 μm, is particularly preferred.

It has proven desirable if the film web includes at least one layer of plastic material, in particular of PET, PET-G, PEN, PE, PC, PVC or ABS. In that respect in particular pure plastic films or also laminates of a further plastic layer with at least one further layer comprising an electrically insulating material which is different therefrom, in particular of plastic material and/or inorganic layers, are suitable.

The electrically conducting layer is applied to the surface of the electrically insulating substrate preferably by vapor deposition, sputtering, chemical vapor phase deposition, embossing or laminating. To improve the adhesion of the electrically conducting layer to the substrate it is also possible in that respect to arrange priming bonding and/or adhesive layers between the substrate and the electrically conducting layer.

When applying the electrically conducting layer by means of embossing (hot or cold embossing) or laminating, embossing or laminating films including the electrically conducting layer are employed, wherein usually an adhesive layer is provided as a bonding layer between the electrically conducting layer and the substrate. That adhesive layer can be a hot melt adhesive, a cold adhesive or an adhesive which sets under the effect of radiation, in particular UV or IR radiation. The adhesive layer can either be arranged on the substrate or can be a component part of the embossing or laminating film.

Embossing films generally have a carrier film and a transfer layer which is detachable therefrom and which is made up of thin layers and which is usually not self-supporting and which is transferred on to the substrate. An embossing film suitable for use in the process according to the invention preferably includes, starting from the carrier film, an optional release layer, the electrically conducting layer and optionally an adhesive layer. Subsequently to the embossing operation in which the electrically conducting layer is glued to the substrate the carrier film is pulled off the transfer layer. Only the transfer layer or regions of the transfer layer remains or remain on the substrate.

Laminating films generally have a carrier film and further thin layers which are not detachable therefrom. They are transferred as a whole on to the substrate. A laminating film suitable for use in the process according to the invention includes on one side of the carrier film the electrically conducting layer and on the other side of the carrier film optionally an adhesive layer. In the laminating operation the laminating film is glued to the substrate or joined thereto under the effect of heat and pressure.

To achieve maximum possible utilisation of the substrate, it has proven desirable if at least two layer structures of a pattern configuration are produced on the substrate. They can be disposed on the substrate in a regular or irregular arrangement. In that respect a regular arrangement is advantageous in particular when primarily layer structures of the same or similar shape, or layer structures of similar dimensions, are to be produced on the substrate.

In that respect an arrangement in the form of lines and/or columns has proven advantageous. In that case the columns are preferably arranged parallel to an edge, in particular a longitudinal edge, of the substrate.

An irregular or any desired arrangement however is equally possible and has proven desirable in particular when layer structures of very different shapes and/or dimensions are to be formed on the substrate.

It is possible for the at least one second region, viewed perpendicularly to the plane of the electrically conducting layer, to be produced at least in region-wise fashion, in the form of at least one elongate conductor track.

It is possible for the electrically conducting layer to be produced with a layer thickness in the region of between 10 nm and 10 μm. The electrically conducting layer is produced on the substrate preferably with a layer thickness in the range of between 100 nm and 5 μm, in particular between 500 nm and 1.5 μm.

Preferably the electrically conducting layer is formed from a metallic and/or electrically conducting organic material. Preferably the electrically conducting layer is formed from copper, aluminum, tin, silver, gold, nickel, chromium, cobalt or alloys of those metals.

In that respect, the same or different materials can be used for forming the electrically conductive layer and the metal layer galvanically deposited thereon.

Equally the electrically conducting layer can be formed from a different electrically conducting material in the first and third regions, than in the second regions. Having regard to economy of the process however it is preferable if the electrically conducting layer is formed in the first, second and third regions from the same electrically conducting material.

It is possible for the galvanically deposited metal layer to be formed from the same or a different material, as the electrically conducting layer.

It has proven desirable if a layer thickness of the galvanically deposited metal layer is thicker than a layer thickness of the electrically conducting layer. It has proven particularly advantageous if a layer thickness of the metal layer is at least 5% thicker than a layer thickness of the electrically conducting layer on which the metal layer is formed. That ensures that in the etching operation the electrically conducting layer can be reliably removed in the first regions, but in any event the galvanically deposited metal layer in the second and third regions remains in a sufficient layer thickness on the substrate. That applies in particular when the same materials are used for forming the electrically conducting layer and the metal layer, the metal layer dissolves in the etching solution used more rapidly than the electrically conducting layer, and so forth.

It has proven to be desirable if the galvanically deposited metal layer is formed from copper, nickel, cobalt, chromium, silver or gold.

An electrically conducting layer of copper in combination with a metal layer of copper has proven advantageous. Other combinations of material are however also possible.

The electrically insulating resist layer is preferably formed from compositions which harden thermally or under the effect of radiation, in particular UV radiation and which are freely available in particular under the name one-component etching resists or galvanoresists. The resist layer is preferably formed in a layer thickness in the region of between 100 nm and 20 μm. The thicker the resist layer is, the correspondingly wider is the width b of the strip-shaped third regions to be generally selected in order to ensure in the galvanic bath electrical contact between the at least one third region of the electrically conducting layer and one or more of the cathode bars. A resist layer of about 20 μm in layer thickness can here already be used without any problem in combination with a strip-shaped third region of a width of 1.0 mm.

A ratio of the layer thickness of the resist layer to the width of a strip-shaped third region of at least 1:50, in particular 1:100, has proven advantageous.

Preferably the resist layer is applied to the substrate in pattern form by printing or embossing. The embossing operation involves using here in particular a hot embossing film.

It is however equally possible for the resist layer to be applied over the full surface area to the substrate, for example in the form of a negative or positive photoresist layer, and then structured, by being removed in the at least one second region and the at least one strip-shaped third region. In that case structuring can be effected photolithographically or by means of a laser.

An electrically conducting layer structure which is formed can be of any desired form. Preferably the layer structure is in the form of an electrode or connecting terminal surface, a conductor track, in particular a conductor track in the shape of a meander or a spiral, or a conductor track arranged in a grid shape, such as for example as an antenna structure, an electrode structure, and so forth.

It is possible that the process also includes the following steps: production of a direct contact between a cathode bar and the at least one strip-shaped third region of the electrically conducting layer in a galvanic bath. The cathode bar is a cathode of a galvanic element suitable for galvanic metal deposition. The direct contact can be produced by a surface of the third region and a surface of the cathode being brought into contact with each other. The direct contact is then produced in an adequate fashion if there is a direct electrical contact between the third region and the cathode, that is to say electric current can flow.

It is preferred that production of the direct contact between the cathode bar and the at least one strip-shaped third region of the electrically conducting layer includes the following steps: guiding the substrate in the form of a flexible film web around a portion of the periphery of a drum which rotates about an axis of rotation and which is at least partially dipped into the galvanic bath and at the periphery of which cathode bars arranged parallel to the axis of rotation are disposed at a mutual spacing, wherein the surface of the substrate to which the electrically conducting layer is applied is oriented towards the drum. The other surface of the substrate which is remote from the electrically conducting layer to be formed faces away from the drum. The cathode bars form the cathodes of the galvanic element. They are arranged substantially parallel to the axis of rotation and thus substantially perpendicular to the direction of transport of the film web of the substrate. It is possible that the anode of the galvanic element is arranged in the region of the axis of rotation of the drum. In that case the peripheral speed of the substrate which is in the form of a flexible film web around the portion of the periphery of the drum is so matched to the speed of rotation of the drum that, during the rotary movement, the film web bears against a periphery of the drum and the at least one strip-shaped third region of the rotating film web assumes a constant position relative to the cathode bars arranged on the periphery.

It is preferred for the at least one third region to be of a strip length as measured in the film web transport direction, which is at least as great as the spacing between adjacent cathode bars, as measured along the periphery. The spacing measured along the periphery between two adjacent bars is defined as the shortest distance between two points on the extended film web, which in the rotation of the film web around the drum, respectively bear against one of the two adjacent cathode bars.

In practice the distance measured along the periphery between two adjacent cathode bars is in the region of at least 20 mm. The diameter of a typical cathode bar is in the region of between about 5 mm and about 50 mm.

It is possible that, in the case of applying the first electrically conducting layer only in region-wise fashion, in particular in a patterned configuration in the form of the electrically conducting layer structure to be formed, the first region of the electrically conducting layer in which the electrically insulating resist layer is produced is the region or regions which electrically conductingly connect together the at least one second and the at least one third region of the electrically conducting layer, in particular the auxiliary conductor tracks. In that case the at least one second region of the electrically conducting layer in the form of the patterned layer structures to be formed and the at least one strip-shaped third region of the electrically conducting layer are left free of the resist layer. Only region-wise application of the electrically conducting layer has the advantage of using a smaller amount of material, in comparison with applying the electrically conducting layer over the full surface layer: that procedure requires less material employed for applying the electrically conducting layer and less material employed for producing the resist layer. In addition, when removing the resist layer less resist material is removed and in the etching operation less material of the electrically conducting layer and less material of the metal layer are removed.

### BRIEF DESCRIPTION OF THE DRAWINGS

FIGS. 1a through 17 are intended to describe by way of example the process according to the invention for the production of an electrically conducting layer structure in pattern form on an electrically insulating substrate. In that respect the individual layers and layer regions are not shown true to scale in their size relationships with each other, for the sake of enhanced clarity. In the Figures:

FIG. 1a shows a cross-section through an embossing film including an electrically conducting layer and also a cross-section through a substrate,

FIG. 1b shows a further possible cross-section through an embossing film including an electrically conducting layer and a cross-section through a substrate,

FIG. 2 shows an operation of applying the electrically conducting layer to the substrate in cross-section,

FIG. 3 shows an operation for detachment of the carrier film of the embossing film from the substrate in cross-section,

FIG. 4a shows an operation of applying a patterned resist layer in cross-section,

FIGS. 4b shows a plan view of the FIG. 4a arrangement,

FIG. 5a shows a unit for application by galvanisation of the second and third regions of the electrically conducting layer with a metal layer in cross-section,

FIG. 5b shows the substrate including the galvanically formed metal layer in cross-section,

FIG. 5c shows a plan view of the arrangement of FIG. 5b,

FIG. 6a shows the arrangement of FIGS. 5 and 5c after removal of the resist layer in cross-section,

FIG. 6b shows a plan view of the arrangement of FIG. 6a,

FIG. 7a shows the arrangement of FIG. 6a after removal of the electrically conducting layer in the first region, with the formation of patterned electrically conducting layer structures,

FIG. 7b shows a plan view of the arrangement of FIG. 7a,

FIG. 8a shows a substrate with an electrically conducting layer produced thereon in patterned form in cross-section,

FIG. 8b shows the arrangement of FIG. 8a in plan,

FIG. 9 shows the arrangement of FIG. 8a after application of a patterned resist layer in plan,

FIG. 10 shows the arrangement of FIG. 9 in plan after the application of a galvanically formed metal layer,

FIG. 11 shows the arrangement of FIG. 10 in plan after removal of the resist layer,

FIG. 12 shows the arrangement of FIG. 11 in plan after removal of the electrically conducting layer in the first region, with the formation of patterned electrically conducting layer structures,

FIG. 13 shows a further substrate with a patterned electrically conducting layer in plan,

FIG. 14 shows the arrangement of FIG. 13 after the application of a patterned resist layer,

FIG. 15 shows the arrangement of FIG. 14 after the application of a galvanically deposited metal layer,

FIG. 16 shows the arrangement of FIG. 15 after removal of the resist layer, and

FIG. 17 shows the arrangement of FIG. 16 after an etching operation.

### DETAILED DESCRIPTION OF THE PREFERRED EMBODIMENTS

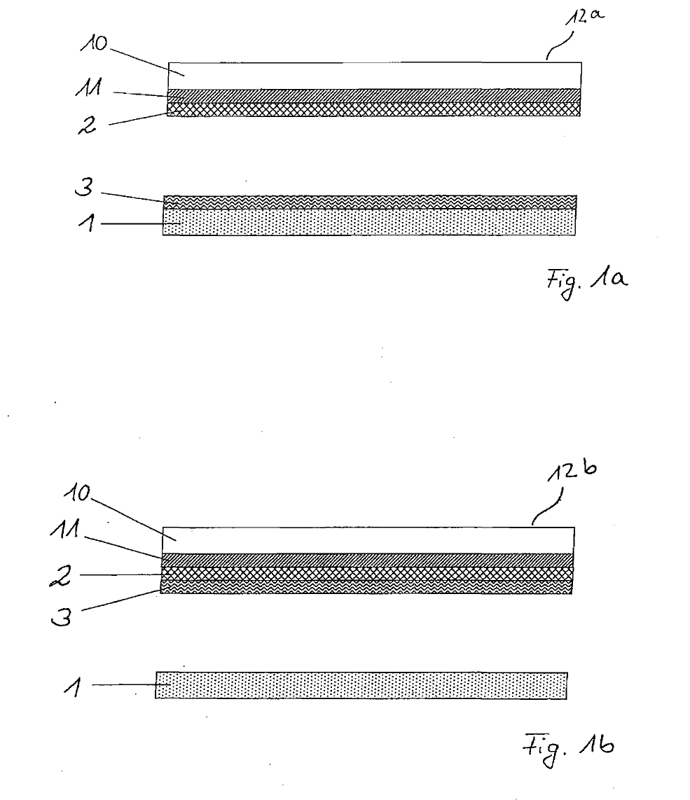

FIGS. 1a and 1b show variants of the process, in which the electrically conducting layer is applied by means of an embossing film to the full surface area on one side of the electrically insulating substrate. As already described hereinbefore however, other procedures for forming the electrically conducting layer on the substrate are also possible, in which no adhesive layer is required between the electrically conducting layer and the electrically insulating substrate, such as for example sputtering, vapor deposition and so forth. A more detailed description of the further possible procedures will not be included here as they are familiar to the man skilled in the art.

FIG. 1a shows a cross-section through an embossing film 12a which includes a carrier film 10, a release layer 11 and an electrically conducting layer 2 of copper of a layer thickness of 500 nm, as well as a cross-section through a substrate 1, the surface of which is formed by an electrically insulating adhesive layer 3.

FIG. 1b shows an alternatively possible cross-section through an embossing film 12b which includes a carrier film 10, a release layer 11, an electrically conducting layer 2 of copper of a layer thickness of 500 nm and an electrically insulating adhesive layer 3, as well as a cross-section through a substrate 1.

The adhesive layer 3 serves in each case for glueing the substrate 1 to the electrically conducting layer 2 and in principle can be viewed as a constituent part of the electrically insulating substrate 1. The release layer 11 of the embossing films 12a, 12b of FIGS. 1a and 1b serves for improving the release performance of the electrically conducting layer 2 from the carrier film 10 and can also be omitted if the electrically conducting layer 2 can in any case be detached from the carrier film 10 to the desired degree.

The substrate 1 is in the form of a flexible film web of plastic material, here PET, of a layer thickness of 50 μm. The substrate 1 is processed in a continuous roll-to-roll process, in which respect only a respective portion of the substrate 1 is illustrated here and hereinafter.

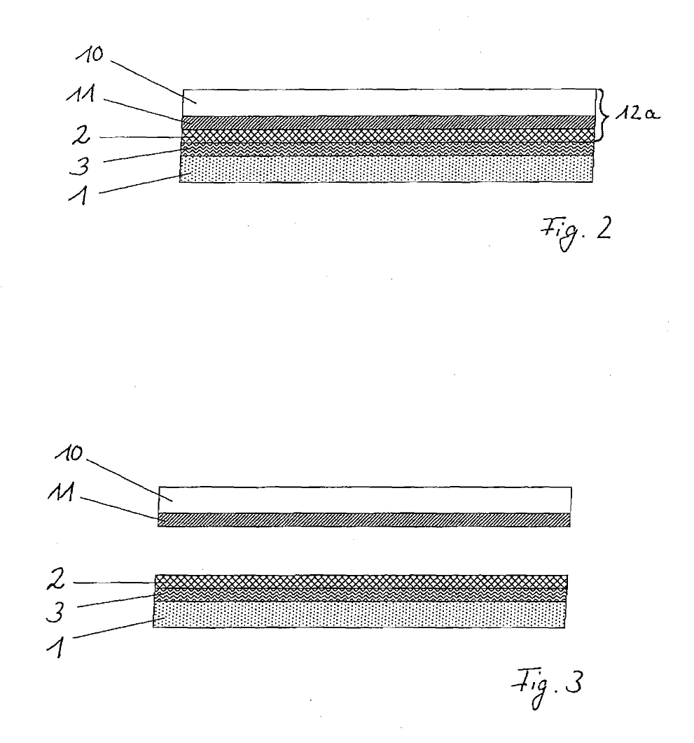

Looking at FIG. 2, viewed in cross-section, the embossing film 12a or alternatively the embossing film 12b is brought together with the substrate 1 and the electrically conducting layer 2 fixed on the substrate 1 by means of the adhesive layer 3. That is effected in conformity with the kind of adhesive layer 3 used. If the adhesive layer 3 is formed from a hot melt adhesive, the glueing operation is effected with an increase in pressure and temperature. If the adhesive layer 3 is formed from an adhesive which is cross-linkable under the effect of UV radiation, either the substrate 1 or the carrier film 10, possibly including the release layer 11, must be transparent in relation to the UV radiation used to permit corresponding irradiation of the adhesive layer 3, and so forth.

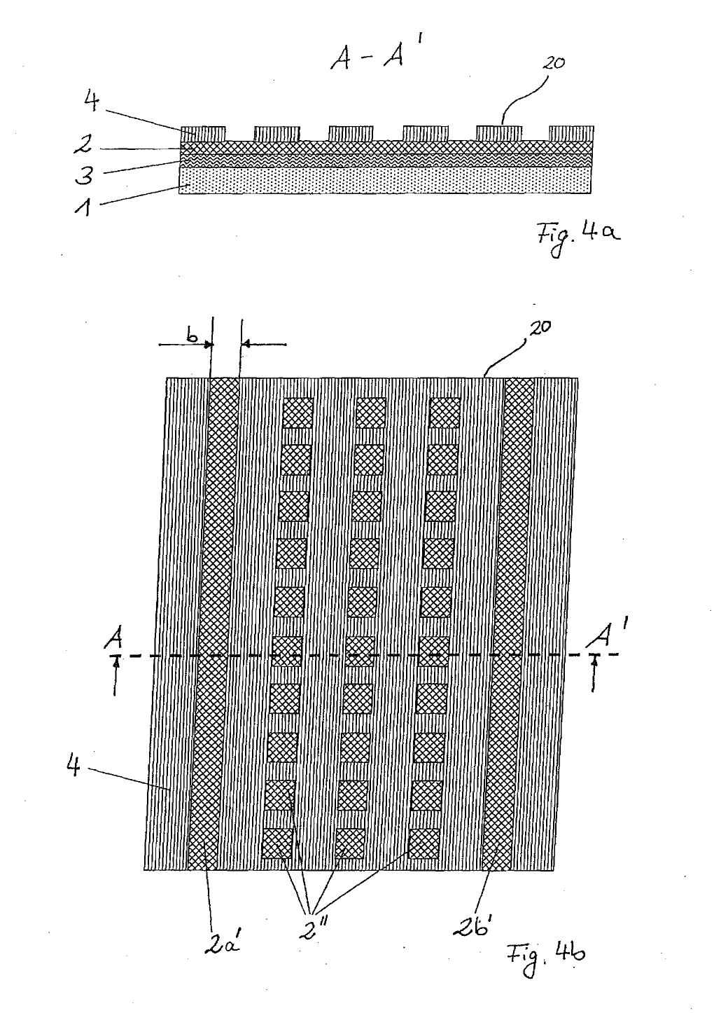

After the adhesive join between the substrate 1 and the electrically conducting layer 2 has been made by means of the adhesive layer 3, then as viewed in cross-section in FIG. 3 the carrier film 10, and if present inclusive of the release layer 11, is pulled off the electrically conducting layer 2. The surface of the substrate 1 is now covered with the electrically conducting layer 2 and is firmly adhesively joined thereto by means of the adhesive layer 3.

Then an electrically insulating resist layer 4 is formed in a pattern configuration on the electrically conducting layer 2, preferably by means of printing. In particular printing processes such as intaglio printing, flexoprinting, screen printing or tampon printing are suitable for that. For example the resist composition SD 2053 UV-AL from Lackwerke Peters is suitable as the printing medium for forming the resist layer 4.

The resist composition is applied by printing in a first region of the electrically conducting layer 2, wherein at least a second region 2″ of the electrically conducting layer 2 is left free in the form of the at least one patterned layer structure to be formed and here moreover at least two strip-shaped third regions 2a′, 2b′ of the electrically conducting layer 2 are left free, each of a width of 1 mm. The at least one second region 2″ is disposed between the third regions 2a′, 2b′, the ends of the third regions 2a′, 2b′ projecting in the longitudinal direction beyond the at least one second region 2″. The strip-shaped third regions 2a′, 2b′ of the electrically conducting layer 2 are arranged parallel to each other and also parallel to and spaced from the longitudinal edges of the substrate 1.

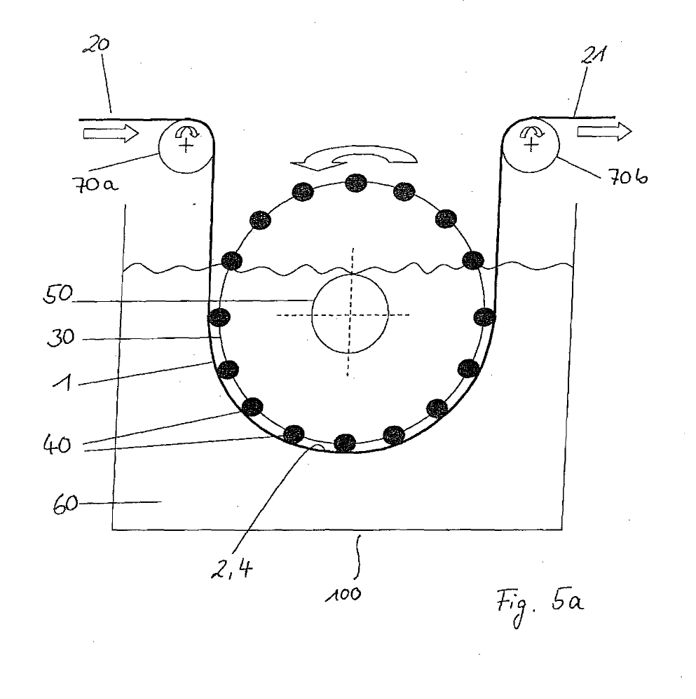

The resulting arrangement 20 with the substrate 1, the adhesive layer 3, the electrically conducting layer 2 and the electrically insulating resist layer 4 which after application is dried and/or hardened is shown in FIG. 4a in cross-section A-A′. In this case the thickness of the resist layer 4 is in the region of between 3 μm and 5 μm.

The patterned configuration of the resist layer 4 formed can be seen in detail from FIG. 4b showing a plan view of the resist layer 4.

Alternatively the resist composition can also be applied over the full surface area and then removed again region-wise, for example photolithographically, to produce the desired pattern.

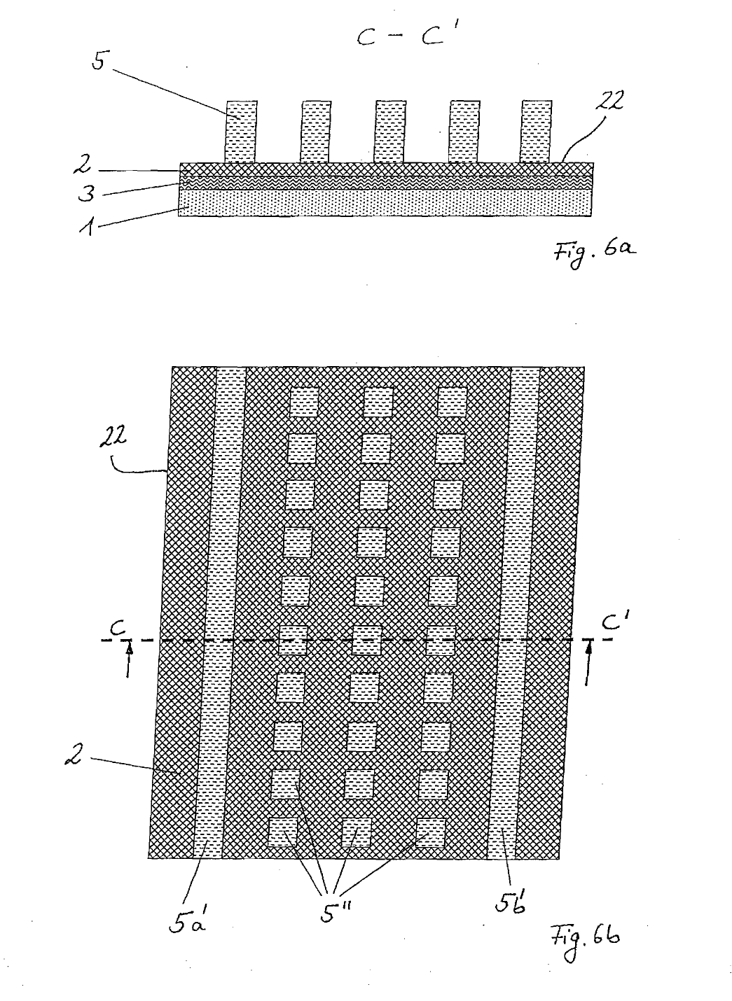

Now the arrangement 20 shown in FIGS. 4a and 4b is passed through at least one galvanic bath. In regard to the structure of a suitable apparatus, attention is also directed for example to FIGS. 1 and 6 of EP 1 562 412 A2.

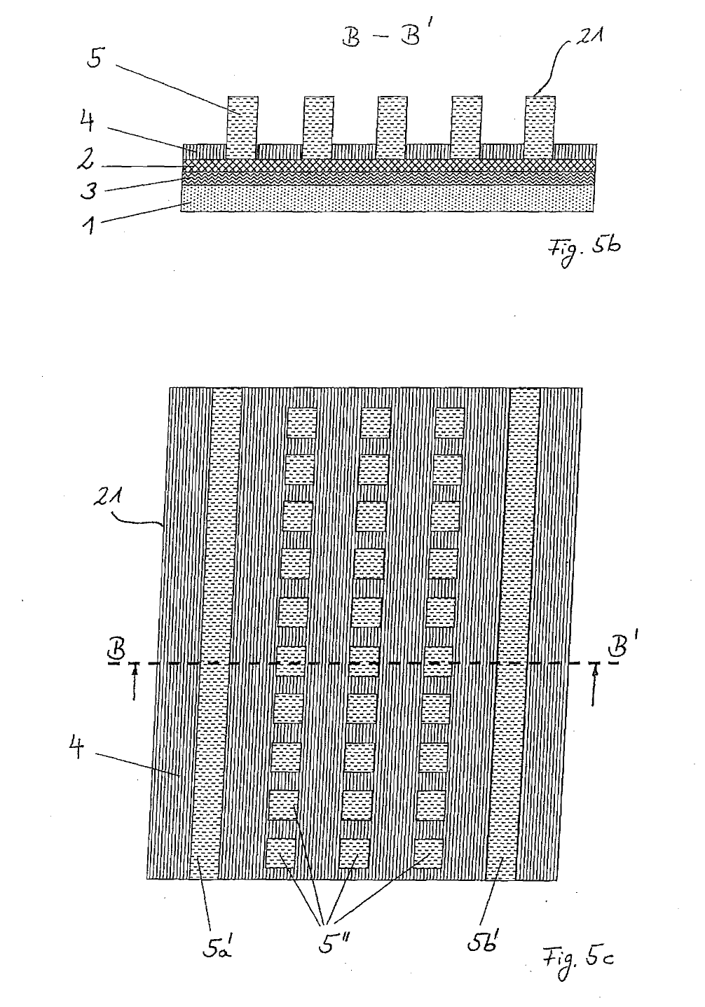

FIG. 5a diagrammatically shows a view in cross-section through a unit 100 for application by galvanisation of the second regions 2″ and the third regions 2a′, 2b′ of the electrically conducting layer 2 with a metal layer, wherein the arrangement 20, depending on the respectively desired thickness of the metal layer, can successively pass through a plurality of such units 100.

A unit 100 includes a tank in which the galvanic bath 60 is disposed. A suitable bath for galvanically depositing a metal layer of copper is for example of the following composition (in parts by weight):

| | |
|---|---|
| 1000 parts | distilled H₂O |
| 50 parts | CuSO₄ |
| 10 parts | HₛSO₄ (98%) |
| 5 parts | L-ascorbic acid |

In order to galvanically deposit a metal layer of copper of for example 12 μm in thickness from such a bath, preferably the following parameters are selected:

| | |
|---|---|
| Deposition voltage | 12 V |
| Current density | about 12 A/dm² |
| Deposition period | about 1.5-2 min |
| Bath temperature | 50° C. |

The thickness of the metal layer becomes correspondingly greater, the higher the current density, deposition voltage and/or deposition period adopted.

A drum 30 of polypropylene is disposed in a position of being at least partially dipped into the galvanic bath 60. Arranged at mutual spacings at the periphery of the drum 30 are cathode bars 40 of high-quality steel arranged parallel to an axis of rotation about which the drum 30 rotates (see the arrow indicated in FIG. 5a, specifying the direction of rotation of the drum 30). In this case the drum 30 is previous at least region-wise for the galvanic bath 60, in the regions which are between the cathode bars 40. Disposed in the region of the axis of rotation of the drum 30 is an anode block 50 of copper. The arrangement 20 shown in FIGS. 4a and 4b is passed over a first guide roller 70a into the galvanic path 60 and around the periphery of the drum 30, the arrangement 20 being so oriented in relation to the drum 30 that the resist layer 4, the second regions 2″ and the third regions 2a′, 2b′ of the electrically conducting layer face towards the drum 30. The cathode bars 40 come at least into contact with the strip-shaped third regions 2a′, 2b′ of the electrically conducting layer 2, in the galvanic bath 60, and electrically contact them, in which case galvanic deposition of metal occurs not only in the third regions 2a′, 2b′ of the electrically conducting layer 2 but also in the second regions 2″ of the electrically conducting layer 2, that are electrically conductingly connected to the third regions 2a′, 2b′. A direct electrical contact between a cathode bar 40 and the second regions 2″ of the electrically conducting layer 2 is no longer required so that plating of second regions 2″ of particularly small dimensions, in particular of a length of less than 20 mm, considered in the direction of transport movement of the substrate 1, is possible.

So that the electrically conducting strip-shaped third regions 2a′, 2b′ of the electrically conducting layer 2 come in any case into direct contact with a cathode bar 40 while passing through the galvanic bath 60, and are electrically conducting contacted, either the resist layer 4 is of a suitably thin nature and/or the width of the strip-shaped third regions 2a′, 2b′ is to be of a suitably large size.

In this respect, the dimension of a strip-shaped third region 2a′, 2b′ (see FIG. 5b) which is oriented parallel to the cathode bar axes is considered as the width b. It generally applies in that respect that, with an increasing thickness of the resist layer 4, the width b of a strip-shaped third region 2a′, 2b′ should proportionally increase.

After passing through the galvanic bath 60, the result is an arrangement 21 as shown in FIG. 5b, which is fed by way of a second guide roller 70b to further galvanisation units or other subsequent processing units.

FIG. 5b shows a view in cross-section B-B′ illustrating the arrangement 21 including the substrate 1, the adhesive layer 3, the electrically conducting layer 2, the resist layer 4 and the metal layer 5 of copper which is galvanically deposited in the second regions 2″ and the third regions 2a′, 2b′ of the electrically conducting layer 2.

The metal layer 3 is of a thickness in the region of between 1 μm and 30 μm which is preferably greater than that of the electrically conducting layer 2 which here is 500 nm in thickness. The metal layer 5 is thicker than the electrically conducting layer 2 in particular when the electrically conducting layer 2 and the metal layer 5 are formed from the same material.

FIG. 5c shows a plan view of the arrangement of FIG. 5b. In the second regions 2″ of the electrically conducting layer 2 it is possible to see regions 5″ of the metal layer 5, which are galvanically deposited thereon, while in the third regions 2a′, 2b′ of the electrically conducting layer 2, it is possible to see regions 5a′, 5b′ also galvanically deposited thereon.

The patterned resist layer 4 is now removed. As shown in FIG. 6a the arrangement 22 is illustrated in cross-section after removal of the resist layer 4. FIG. 6b shows the arrangement 22 of FIG. 6a, that is to say without the resist layer 4, as a plan view. The regions covered with the metal layer 5 are disposed beside the first regions of the electrically conducting layer 2, that have been freed of the resist layer, wherein the regions 5″ of the metal layer 5 are arranged in the second regions 2″ of the electrically conducting layer 2 (see FIG. 4b) and the regions 5a′, 5b′ of the metal layer 5 are arranged in elongate form or strip shape in the strip-shaped third regions 2a′, 2b′ of the electrically conducting layer 2.

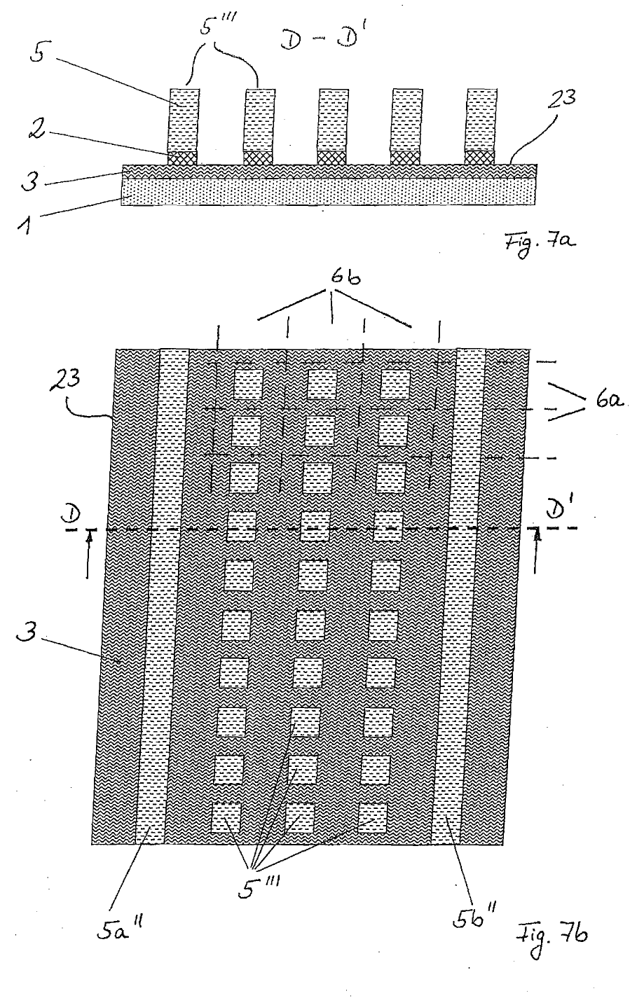

Now, as shown in FIG. 7a, an arrangement 23 having a multiplicity of electrically conducting layer structures 5″ in pattern form is produced, as shown here in cross-section. For that purpose the arrangement 22 of FIG. 6a or FIG. 6b is dipped into an etching solution or brought into contact with such a solution which dissolves at least the material from which the electrically conducting first layer 2 is formed. If the metal layer 5 is formed from the same material as the electrically conducting layer 2 it is also attacked by the etching solution and partially removed. So that the electrically conducting layer 2 can be certain to be removed in the exposed first region and at the same time the metal layer 5 and the regions 2″, 2a′, 2b′, covered thereby, of the electrically conducting layer 2 substantially remain, the metal layer 5 is preferably thicker than the electrically conducting layer 2. In that way the electrically conducting layer 2 is removed by etching in the first region and in addition the metal layer 5 is respectively removed by etching on its side remote from the substrate 1, until the electrically conducting layer 2 is removed in the first region.

If different materials are employed for forming the electrically conducting layer 2 and the metal layer 5 and an etching solution is used which in particular attacks the material of the electrically conducting layer 2 while the metal layer 5 is not attacked or is substantially not attacked and in addition is also not previous for the etching solution, it is also possible to use a metal layer 5 which is of the same thickness as or thinner than the electrically conducting layer 2. It will be noted however that the thickness of the metal layer 5 is crucial for the electrical resistance of the patterned electrically conducting layer structure 5″′ so that here a natural lower limit for the layer thickness is reached when the desired electrical conductivity of the layer structure 5″′ is no longer attained.

FIG. 7b shows a plan view illustrating the patterned electrically conducting layer structure 5″′ on the electrically insulating adhesive layer 3 disposed on the electrically insulating substrate 1.

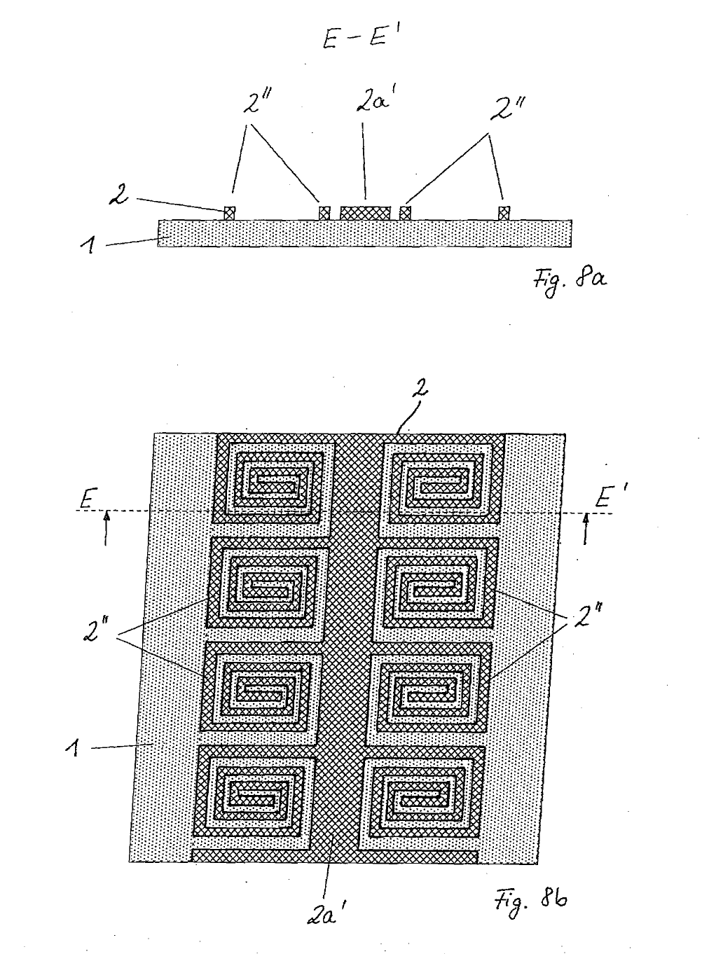

FIG. 8a shows an electrically insulating substrate 1 of PC with an electrically conducting layer 2 produced thereon in a pattern configuration, in cross-section E-E′ (see FIG. 8b). In this case the electrically conducting layer 2 is applied to the substrate 1 in pattern form. In this respect the electrically conducting layer has a plurality of second regions 2″ in the form of the patterned layer structures to be formed and a strip-shaped third region 2a′.

FIG. 8b shows a plan view of the FIG. 8a arrangement. It will be seen that the electrically conducting layer 2 is admittedly in a patterned configuration but the individual regions of the electrically conducting layer 2 are electrically conductingly connected together. In that respect it is possible to see eight second regions 2″ electrically conductingly connected to the strip-shaped third region 2a′. The second regions 2″ are arranged to the right and the left beside the third region 2a′, wherein the third region 2a′, viewed in the longitudinal direction of the substrate 1, connects the second regions 2″ together and projects therebeyond. The strip-shaped third region 2a′ of the electrically conducting layer 2 is arranged spaced from the longitudinal edges of the substrate 1 centrally thereon.

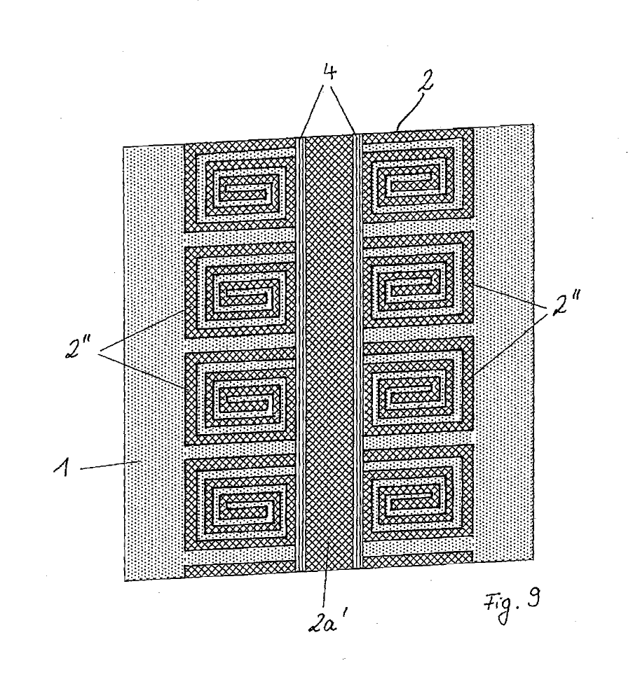

Referring to FIG. 9 an electrically insulating resist layer 4 is applied in patterned configuration to the electrically conducting layer 2, preferably by printing. In particular printing processes such as intaglio printing, flexoprinting, screen printing or tampon printing are suitable for that purpose. Here for example the resist composition SD 2053 UV-AL from Lackwerke Peters is also suitable as the printing medium for forming the resist layer 4.

The resist composition is applied by printing in a first region of the electrically conducting layer 2, wherein the second regions 2″ of the electrically conducting layer 2 are left free in the form of the patterned layer structures to be formed, and in addition the strip-shaped third region 2a′ of the electrically conducting layer 2, of a width of 1 mm, is left free.

The thickness of the hardened resist layer 4 in this case is in the region of between 3 μm and 5 μm.

The arrangement shown in FIG. 9, for galvanising application of the second regions 2″ and the third region 2a′ of the electrically conducting layer 2, with a metal layer 5, is now passed through at least one galvanic bath (see FIG. 5a).

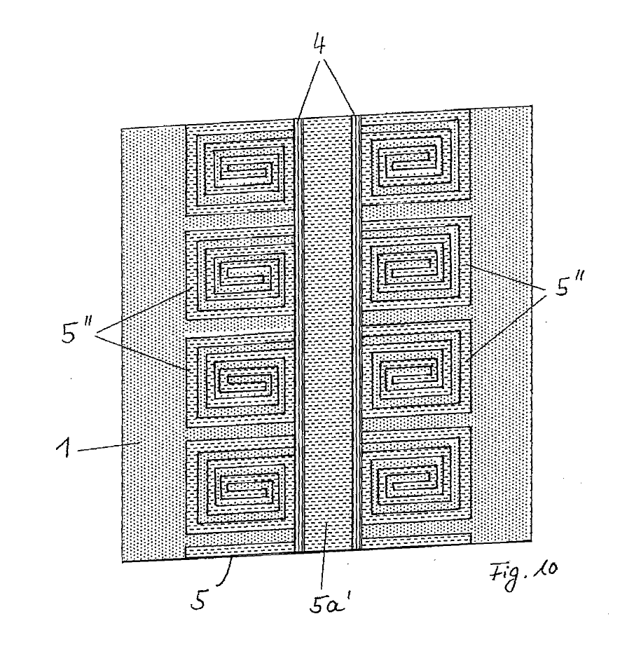

After passing through the galvanic bath the result is an arrangement as shown in FIG. 10. The metal layer 5 is produced in a layer thickness in the region of between 1 μm and 30 m, which is preferably greater than that of the electrically conducting layer 2 which here is 500 nm in thickness. In the second regions 2″ (see FIG. 9) of the electrically conducting layer it is possible to see regions 5″ of the metal layer 5, that are galvanically deposited thereon, while in the third region 2a′ (see FIG. 9) of the electrically conducting layer 2 it is also possible to see a region 5a′ of the metal layer 5, that is galvanically deposited thereon. It is only in the first regions of the electrically conducting layer 2, that are covered with the resist layer 4, that no galvanic metal deposition occurs.

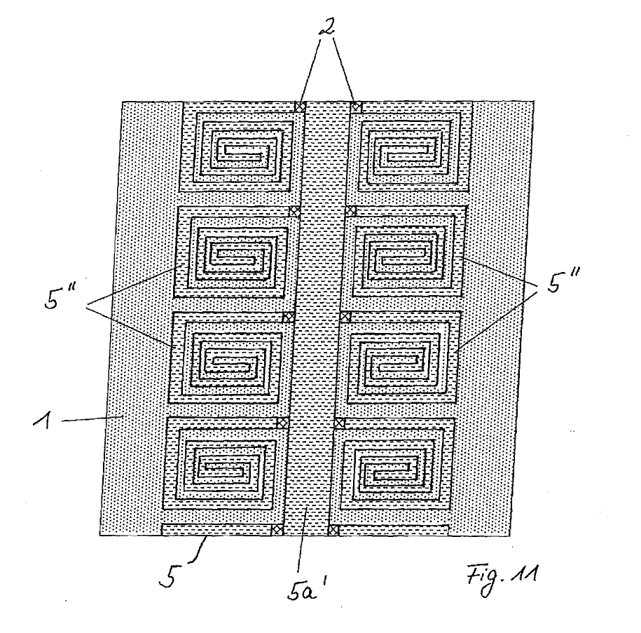

Removal of the patterned resist layer 4 is now effected. Referring to FIG. 11, shown therein is a plan view of the arrangement after removal of the resist layer 4. Disposed beside the first regions which have been freed of the resist layer 4 and in which it is possible to see the electrically conducting layer 2 are the regions which are covered with the metal layer 5, wherein the regions 5″ of the metal layer 5 are disposed in the second regions 2″ of the electrically conducting layer 2 and the region 5a′ of the metal layer 5 is arranged in elongate shape or strip form in the strip-shaped third region 2a′ of the electrically conducting layer 2.

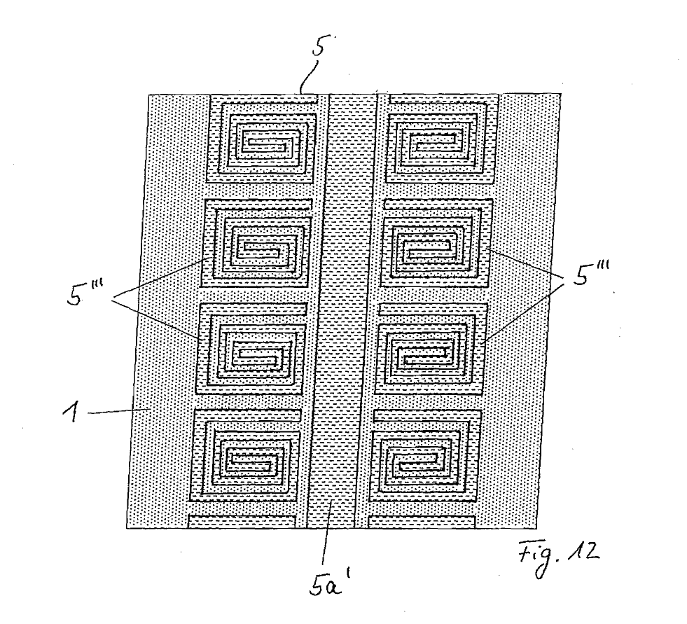

The arrangement shown in FIG. 11 is now etched so that electrically conducting layer structures 5″′ of a pattern configuration are now produced, as shown in FIG. 12. For that purpose the arrangement of FIG. 11 is dipped into an etching solution or brought into contact with such a solution, which dissolves at least the material forming the electrically conducting first layer 2. If the metal layer 5 is formed from the same material as the electrically conducting layer 2 it is also attacked by the etching solution and partially removed. So that the electrically conducting layer 2 can be certain to be removed in the exposed first region and at the same time the metal layer 5 and the second and third regions 2″, 2a′ of the electrically conducting layer 2, that are covered thereby, substantially remain, the metal layer 5 is preferably thicker than the electrically conducting layer 2. Thus the electrically conducting layer 2 is removed in the first region and in addition the metal layer 5 is respectively removed on its side remote from the substrate 1, by etching, until the electrically conducting layer 2 is removed in the first region.

The eight patterned electrically conducting layer structures 5″′ formed, which here are each of a spiral configuration, are electrically insulated from each other and are disposed in isolated relationship from each other on the electrically insulating substrate 1.

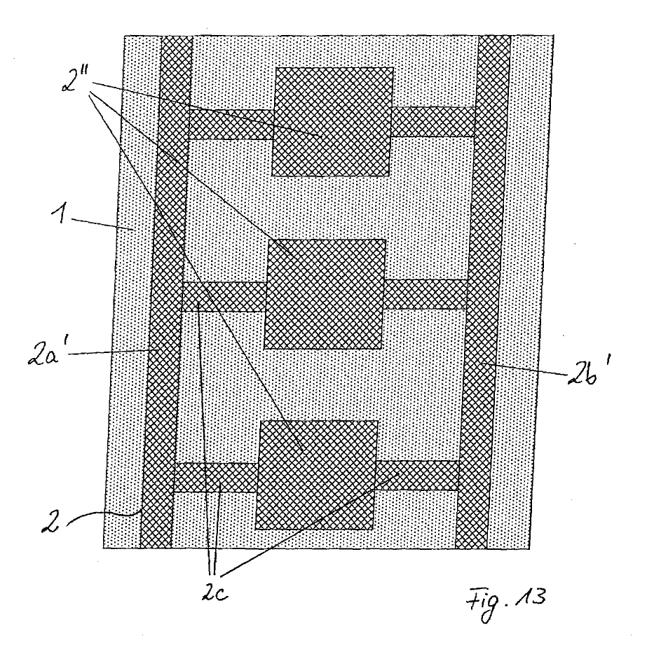

FIG. 13 shows a plan view of an electrically insulating substrate 1 of PC, with an electrically conducting layer 2 provided in patterned configuration thereon. In this case the electrically conducting layer 2 has a plurality of second regions 2″ in the form of the patterned layer structures to be formed, and two strip-shaped third regions 2a′, 2b′. It will be seen that the electrically conducting layer 2 is admittedly of a patterned configuration, but the individual regions of the electrically conducting layer 2 are electrically conductingly connected together. This arrangement has three second regions 2″ electrically conductingly connected to the strip-shaped third regions 2a′ by way of auxiliary conductor tracks 2c which are a constituent part of the electrically conducting layer 2. The second regions 2″ are disposed between the two third regions 2a′, 2b′, wherein the third regions 2a′, 2b′, viewed in the longitudinal direction of the substrate 1, connect the second regions 2″ together and project therebeyond. The strip-shaped third regions 2a′, 2b′ of the electrically conducting layer 2 are arranged spaced from the longitudinal edges of the substrate 1.

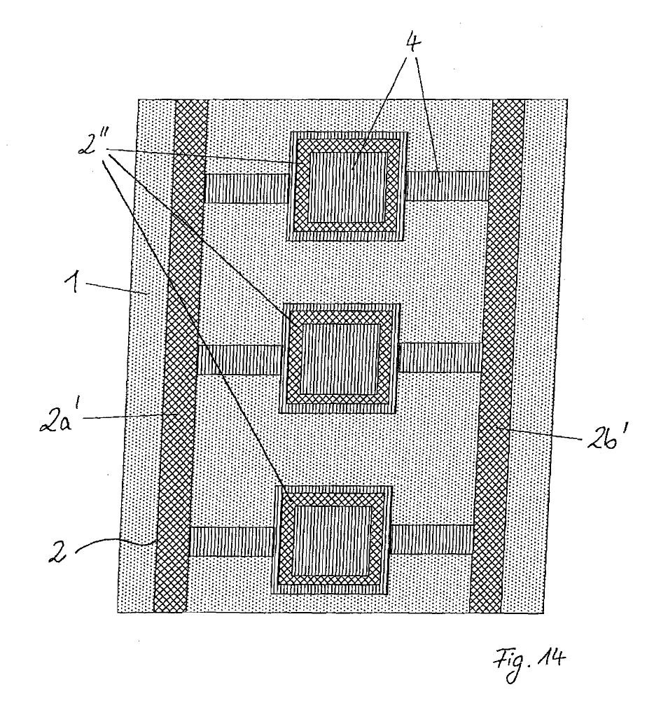

Referring to FIG. 14, an electrically insulating resist layer 4 is applied in a pattern configuration to the electrically conducting layer 2, preferably by printing. The resist composition is applied by printing in a first region of the electrically conducting layer 2, wherein the second regions 2″ of the electrically conducting layer 2 are left free, in the form of the patterned layer structures to be formed, and in addition the strip-shaped third regions 2a′, 2b′ of the electrically conducting layer 2 are left free, of a width in each case of 1 mm. In this case the thickness of the hardened resist layer 4 is in the region of between 3 μm and 5 μm.

The arrangement shown in FIG. 14, for galvanisation application of the second regions 2′ and the third regions 2a′, 2b′ of the electrically conducting layer 2, with a metal layer 5, is now passed through at least one galvanic bath (see FIG. 5a).

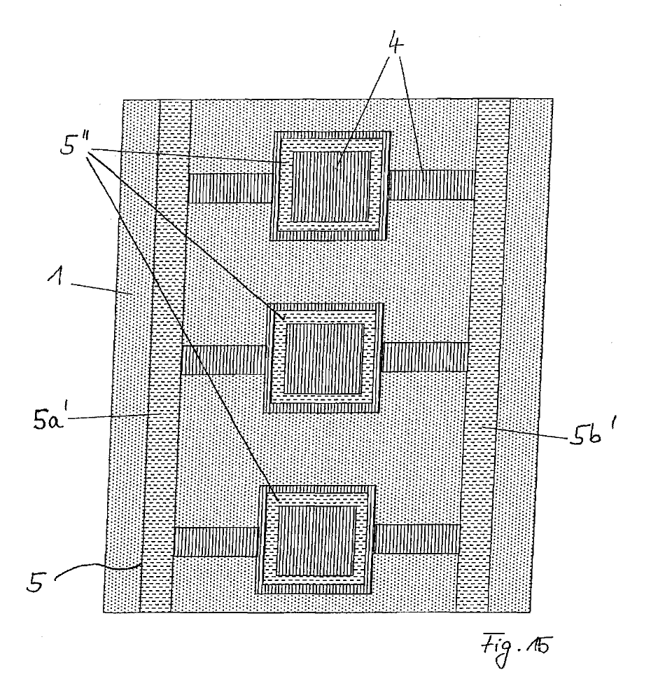

After passing through the galvanic bath the result is an arrangement as shown in FIG. 15. The metal layer 5 is produced with a layer thickness in the region of between 1 μm and 30 μm, which is preferably greater than that of the electrically conducting layer 2 which here is 500 nm in thickness. In the second regions 2″ (see FIG. 14) of the electrically conducting layer 2, it is possible to see regions 5″ of the metal layer 5, that are galvanically deposited thereon, while in the third regions 2a′, 2b′ (see FIG. 14) of the electrically conducting layer 2 it is possible to see regions 5a′, 5b′ of the metal layer, which are also galvanically deposited thereon. It is only in the first regions of the electrically conducting layer 2, that are covered with the resist layer 4, that no galvanic metal deposition takes place.

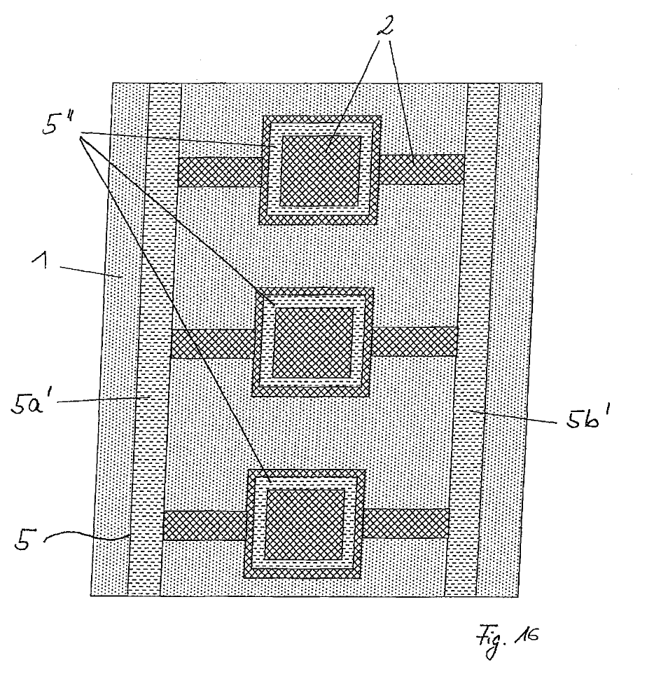

Removal of the patterned resist layer 4 is now effected. Referring to FIG. 16 this shows a plan view of the arrangement after removal of the resist layer 4. Disposed beside the first regions which are freed of the resist layer 4 and in which it is now again possible to see the electrically conducting layer 2 are the regions covered with the metal layer 5, wherein the regions 5″ of the metal layer 5 are disposed in the second regions 2″ of the electrically conducting layer 2 and the regions 5a′, 5b′ of the metal layer 5 are arranged in an elongate shape or in strip form in the strip-shaped third regions 2a′, 2b′ of the electrically conducting layer 2.

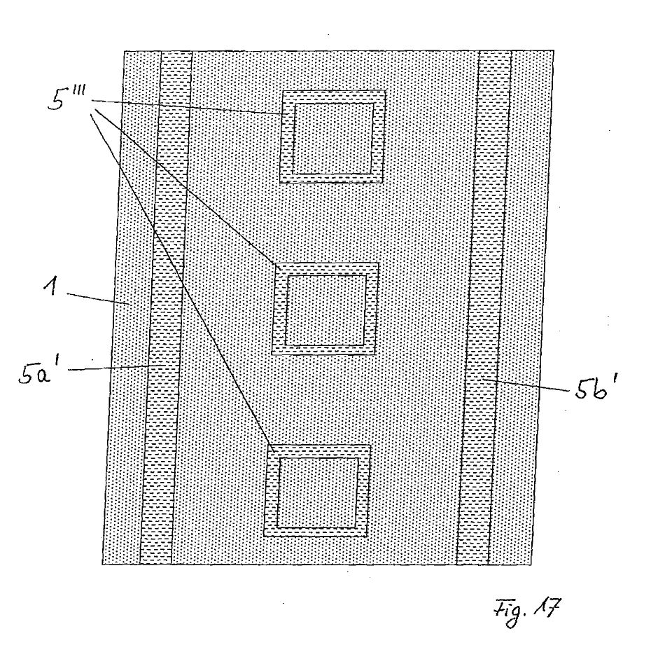

The arrangement shown in FIG. 16 is now etched so that patterned electrically conducting layer structures 5″′ are now produced, as shown in FIG. 17. For that purpose the arrangement of FIG. 16 is dipped into an etching solution or brought into contact with such a solution which dissolves at least the material forming the electrically conducting first layer 2. If the metal layer 5 is formed from the same material as the electrically conducting layer 2 it is in any event also attacked by the etching solution and partially removed. So that the electrically conducting layer 2 can be certain to be removed in the exposed first region and at the same time the metal layer 5 and the regions 2″, 2a′, 2b′, covered thereby, of the electrically conducting layer 2 substantially remain, the metal layer 5 is preferably thicker than the electrically conducting layer 2.

Thus the electrically conducting layer 2 is removed in the first region and in addition the metal layer 5 is respectively removed on its side remote from the substrate 1, by etching, until the electrically conducting layer 2 is removed in the first region.

The three patterned electrically conducting layer structures 5″′ formed which here are each of a frame-shaped configuration are electrically insulated from each other and are disposed in isolated relationship on the electrically insulated substrate 1.

FIGS. 1a through 17 only show diagrammatic views illustrating the configuration of the patterned electrically conducting layer structure. It will however be readily apparent to the man skilled in the art in this respect that here it is possible to produce not just layer structures of a simple shape but various shapes and filigree patterns on layer structures, for example complicated antennae, meander-shaped conductor tracks and the like, of extremely small dimensions, particularly when considered in the direction of transport movement of the substrate 1.

In addition the layer structure formed is not limited to the metal layer being formed from one material. Rather, different materials can be deposited in successively connected galvanisation units and a layer structure can thus comprise a multi-layer metal layer which is made up by individual layers of different metals.

1. A method for the production of at least one electrically conducting layer structure of a pattern configuration on an electrically insulating substrate, the method comprising the steps of:
applying an electrically conducting layer to at least one surface of the substrate;
producing an electrically insulating resist layer in a first region of the electrically conducting layer, wherein at least one second region of the electrically conducting layer is left free in the shape of the at least one patterned layer structure to be formed and in addition at least one strip-shaped third region of the electrically conducting layer is left free, wherein the first, second and third regions of the electrically conducting layer are electrically conductingly connected together and the at least one third region has ends which viewed in the longitudinal direction of the at least one third region project at least at one side beyond the at least one second region;
galvanically depositing a metal layer in the at least one second region and the at least one third region of the electrically conducting layer;
removing the resist layer; and
producing the at least one patterned layer structure by the removal by etching of the electrically conducting layer in the first region and in addition the metal layer respectively on the side thereof that is remote from the substrate until the electrically conducting layer is removed in the first region.

2. A method as set forth in claim 1, wherein at least two strip-shaped third regions are produced.

3. A method as set forth in claim 1, wherein the at least one third region is of a strip length of at least 20 mm.

4. A method as set forth in claim 1, wherein the at least one third region is produced adjoining an edge, in particular a longitudinal edge, of the substrate.

5. A method as set forth in claim 1, wherein the at least one third region is provided spaced from a longitudinal edge of the substrate.

6. A method as set forth in claim 1, wherein the at least one strip-shaped third region is of such a configuration that it extends over a length of the substrate.

7. A method as set forth in claim 1, wherein the at least strip-shaped one third region is of such a configuration that it extends only over a portion of the substrate.

8. A method as set forth in claim 7, wherein a multiplicity of third regions are arranged in succession in the longitudinal direction of the substrate.

9. A method as set forth in claim 7, wherein at least two strip-shaped third regions are formed, the ends of which are arranged at the same height or in mutually displaced relationship on the substrate.

10. A method as set forth in claim 8, wherein at least two strip-shaped third regions are of such a configuration that they are of different lengths.

11. A method as set forth in claim 1, wherein the at least one strip-shaped third region is of such a configuration that it is of a width b of at least 1.0 mm.

12. A method as set forth in claim 1, wherein at least two strip-shaped third regions are formed, which are of a differing width b.

13. A method as set forth in claim 1, wherein at least two layer structures of a pattern configuration are produced on the substrate.

14. A method as set forth in claim 1, wherein an elongate flexible substrate is used.

15. A method as set forth in claim 14, wherein the process is carried out while the substrate is transported from roll to roll.

16. A method as set forth in claim 14, wherein a film web is used as the substrate.

17. A method as set forth in claim 16, wherein the film web includes at least one layer of plastic material, in particular of PET, PET-G, PE, PEN, PC, PVC or ABS.

18. A method as set forth in claim 1, wherein the electrically conducting layer is applied to the surface of the substrate by vapor deposition, sputtering, chemical vapor phase deposition, embossing or laminating.

19. A method as set forth in claim 1, wherein the electrically conducting layer is produced with a layer thickness in the region of between 10 nm and 10 μm.

20. A method as set forth in claim 1, wherein the electrically conducting layer is applied over the full surface area to the surface of the substrate.

21. A method as set forth in claim 1, wherein the electrically conducting layer is applied only region-wise to the surface of the substrate.

22. A method as set forth in claim 1, wherein the electrically conducting layer is formed from a metallic and/or electrically conducting organic material.

23. A method as set forth in claim 1, wherein a layer thickness of the metal layer is thicker than a layer thickness of the electrically conducting layer.

24. A method as set forth claim 1, wherein a layer thickness of the metal layer is at least 5% thicker than a layer thickness of the electrically conducting layer on which the metal layer is formed.

25. A method as set forth in claim 1, wherein the at least one second region, viewed perpendicularly to the plane of the electrically conducting layer, is produced at least region-wise in the form of at least one elongate conductor track.

26. A method as set forth in claim 1, wherein the metal layer is formed from the same or a different material as the electrically conducting layer.

27. A method as set forth in claim 1, wherein the galvanically deposited metal layer is formed from copper, nickel, cobalt, chromium, silver or gold.

28. A method as set forth in claim 1, wherein the resist layer is produced in a layer thickness in the region of between 100 nm and 20 μm.

29. A method as set forth in claim 1, wherein the resist layer is applied in pattern form to the substrate by printing or embossing.

30. A method as set forth in claim 1, wherein the resist layer is applied over the full surface area to the substrate and then structured by being removed in the at least one second region and the at least two strip-shaped third regions.

31. A method as set forth in claim 1, further including the step of producing a direct contact between a cathode bar and the at least one strip-shaped third region of the electrically conducting layer in a galvanic bath.

32. A method as set forth in claim 31, wherein production of the direct contact between the cathode bar and the at least one strip-shaped third region of the electrically conducting layer includes the following steps:
guiding the substrate in the form of a flexible film web around a portion of the periphery of a drum which rotates about an axis of rotation and which is at least partially dipped into the galvanic bath and at the periphery of which cathode bars arranged parallel to the axis of rotation are disposed at a mutual spacing, wherein the surface of the substrate to which the electrically conducting layer is applied is oriented towards the drum.

33. An electrically conducting layer structure on an electrically insulating substrate produced by the method set forth in claim 1, wherein the layer structure is of dimensions of smaller than 20 mm in all directions.

34. An electrically conducting layer structure as set forth in claim 33, wherein the layer structure is of dimensions of smaller than 1 mm in the plane of the layer in all directions.
